(19) United States
(12) Patent Application Publication
(10) Pub. No.: US 2011/0001655 A1
(43) Pub. Date: Jan. 6, 2011

(54) DETERMINING PHYSICAL PROPERTIES OF STRUCTURAL MEMBERS IN DYNAMIC MULTI-PATH CLUTTER ENVIRONMENTS

(75) Inventors: Eric K. Walton, Columbus, OH (US); Yakup Bayram, Dublin, OH (US); Orbay Tuncay, Emmaus, PA (US); Bruce G. Montgomery, Glenwood, MD (US); Gary W. Bruce, Severna Park, MD (US); Douglas E. Crowe, Herdon, VA (US); Steven E. Gemeny, Montgomery Village, MD (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignees: THE OHIO STATE UNIVERSITY RESEARCH FOUNDATION, Columbus, OH (US); SYNTONICS LLC, Columbia, MD (US)

(21) Appl. No.: 12/330,134

(22) Filed: Dec. 8, 2008

Related U.S. Application Data
(60) Provisional application No. 61/012,186, filed on Dec. 7, 2007.

(51) Int. Cl. G01S 13/74

(52) U.S. Cl. 342/51; 342/159

(57) ABSTRACT

A method for determining a physical property of a structural member in a dynamic multi-path clutter environment is given. The method comprises transmitting an RF interrogation signal to a wireless sensor operable to receive the RF interrogation signal, produce a reference signal and a measurement signal, and transmit the reference signal and the measurement signal in the dynamic multi-path clutter environment. The reference signal is delayed by a first time delay and the measurement signal is delayed by a second time delay that is a function of the physical property to be determined. The first and second time delays are associated by a known relationship defined by the wireless sensor. The method further comprises receiving the transmitted reference signal and the transmitted measurement signal and comparing the transmitted reference signal and the transmitted measurement signal in the time domain. Finally, the method comprises using this comparison to determine the physical property of the structural member.

### CROSS-REFERENCE TO RELATED APPLICATIONS

This patent application claims priority to provisional Patent Application Ser. No. 61/012,186, filed Dec. 7, 2007.

### STATEMENT REGARDING FEDERALLY SPONSORED RESEARCH OR DEVELOPMENT

This invention was made with government support under Contract No. FA9550-065-C-0157 awarded by Air Force Office of Scientific Research/PKC. The Government has certain rights in this invention.

### BACKGROUND

The present invention relates generally to measuring the physical properties of a component and, more particularly to methods and sensors for determining the physical properties of structural members in dynamic multi-path clutter environments.

It is often necessary to measure physical properties such as temperature, strain, pressure, etc. using a wireless system. In some cases, there are a large number of moving multiple reflections (multi-path signal propagation in a dynamic environment) of the radio signals along the propagation path so that the signal from the sensor will be corrupted by the multi-path environment and modulated by the dynamic environment. When there is a number of varying coherent signal reflections along the propagation path, the result is multi-path induced variations in the phase and amplitude and time domain character of the signal. This situation presents a very serious problem for sensor system design. Also, practical constraints on sensor placement, weight, size, temperature and lifetime requirements present problems to engineers in the design of very small and light weight sensors that can operate wirelessly without a source of power.

For the purposes of describing and defining the present invention, it is noted that “dynamic multi-path clutter environment” refers to an environment in which electromagnetic waves are transmitted and received in the presence of reflecting structures that are moving within or through the environment. The reflecting structures are capable of reflecting the electromagnetic waves such that an electromagnetic wave sent through this environment may be reflected off numerous reflecting structures before reaching its intended destination. As a result of these reflections, the amplitude and time delay of the transmitted electromagnetic wave may be shifted when it reaches its intended destination. Furthermore, since the reflecting structures are moving within or through the environment, the particular reflections experienced by individual electromagnetic signals will vary in an unpredictable manner.

### BRIEF SUMMARY

According to one embodiment of the present invention, a method for determining a physical property of a structural member in a dynamic multi-path clutter environment is given. The method comprises transmitting an RF interrogation signal to a wireless sensor physically coupled to the structural member in the dynamic multi-path environment. The wireless sensor is operable to receive the RF interrogation signal, produce a reference signal and a measurement signal, and transmit the reference signal and the measurement signal in the dynamic multi-path clutter environment. The reference signal and the measurement signal are derived from the RF interrogation signal. The reference signal is delayed by a first time delay and the measurement signal is delayed by a second time delay that is a function of the physical property to be determined. The first and second time delays are associated by a known relationship defined by the wireless sensor. The method further comprises receiving the transmitted reference signal and the transmitted measurement signal and comparing the transmitted reference signal and the transmitted measurement signal in the time domain. Finally, the method comprises using this comparison to determine the physical property of the structural member.

In accordance with another embodiment of the present invention, a system for determining a physical property of a structural member in a dynamic multi-path clutter environment is given. The system comprises a transponder, a wireless sensor, and a signal processing unit. The transponder is operable to transmit a wireless RF interrogation signal to the wireless sensor in a dynamic multi-path clutter environment and receive wireless signals transmitted by the wireless sensor in a dynamic multi-path clutter environment. The wireless sensor is operable to receive the RF interrogation signal transmitted by the transponder, produce a reference signal and a measurement signal, and transmit the reference signal and the measurement signal in the dynamic multi-path clutter environment. The reference signal and measurement signal are derived from the RF interrogation signal. The reference signal is delayed by a first time delay that is optionally a function of the physical property to be determined, and the measurement signal is delayed by a second time delay that is a function of the physical property to be determined. The signal processing unit is electrically coupled to the transponder and is operable to compare the reference signal and the measurement signal in the time domain and, using this comparison, determine the physical property of the structural member.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 depicts one embodiment of the wireless sensor system;

FIGS. 2A and 2B depict one embodiment of the wireless sensor;

FIG. 3 depicts one embodiment of a SAW device; and

FIG. 4 depicts one embodiment of the temporal relationship between the RF interrogation signal, the reference signal, and the measurement signal.

### DETAILED DESCRIPTION

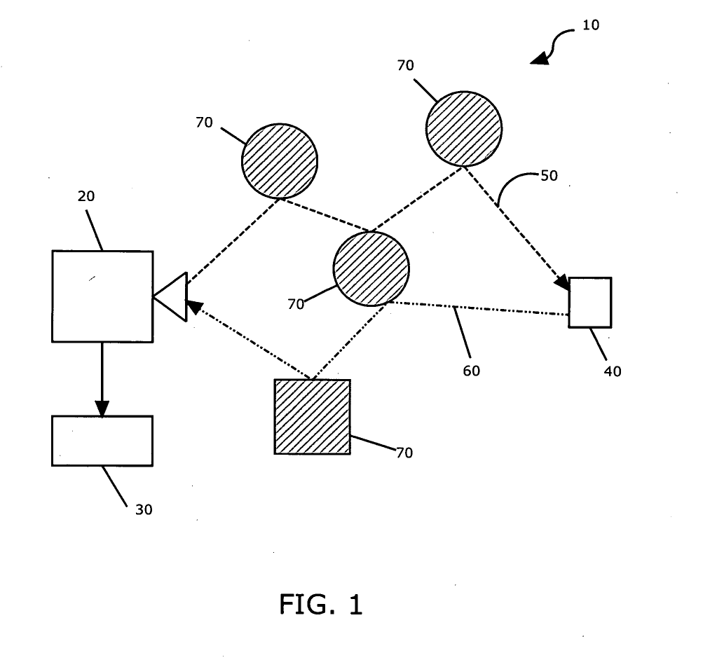

FIG. 1 depicts a wireless sensor system 10 which may operate in a dynamic multi-path clutter environment. The wireless sensor system 10 comprises a transponder 20, a signal processing unit 30, and a wireless sensor 40. The dynamic multi-path clutter environment comprises a plurality of reflecting structures 70, which are operable to reflect electromagnetic signals transmitted within the environment. Some or all of the reflecting structures are moving within or through the environment. As shown in FIG. 1, the reflecting structures 70 may assume a number of different shapes. In addition, the reflecting structures 70 may comprise a number of different materials, and any single structure may comprise multiple materials. The movement of the reflecting structures 70 may be constant, random, or periodic, etc. An individual reflecting structure 70 may move independent of the other reflecting structures or may move in a dependent fashion. Finally, the movement of the reflecting structures 70 may be in any axis of motion, both linear and rotational motion. In summary, it is contemplated that the reflecting structures 70 in the dynamic multi-path clutter environment can move in any direction at any time.

Continuing to refer to FIG. 1, the transponder 20 is operable to transmit a wireless RF interrogation signal 50 to the wireless sensor 40 in the dynamic multi-path clutter environment. The RF interrogation signal 50, as shown in FIG. 1, may reflect off several reflecting structures 70 before reaching the wireless sensor 40. In the exemplary figure, the RF interrogation signal 50 reflects three times before being received by the wireless sensor 40. Subsequent RF interrogation signals may reflect more or less times, depending on the physical arrangement of the reflecting structures at the instant of time of the RF interrogation signal 50 is transmitted. The transponder is also operable to receive wireless signals transmitted by the wireless sensor 40 in the dynamic multi-path clutter environment. A return signal 60 transmitted by the wireless sensor 40 to the transponder 20 may also be reflected by the reflecting structures 70. In the exemplary figure, the return signal 60 reflects two times before being received by the transponder 20. Subsequent return signals 60 may reflect more or less times, depending on the physical arrangement of the reflecting structures and the instant of time the return signal 60 is transmitted. Furthermore, and as indicated in FIG. 1, the RF interrogation signal 50 and the return signal 60 may take completely independent paths and may reflect off different reflecting structures 70.

The wireless sensor 40, which may be moving very rapidly relative to the transponder 20 (i.e., with peak velocities exceeding 1,000 feet per second), is operable to receive the RF interrogation signal 50 transmitted by the transponder 20, produce a reference signal and a measurement signal, and transmit the reference signal and the measurement signal to the transponder in the dynamic multi-path clutter environment. In FIG. 1, the reference signal and the measurement signal are both represented by the return signal 60. The reference signal and the measure signal will generally take the same path before being received by the transponder 20. Like the RF interrogation signal 50, the reference signal and the measurement signal will likely reflect off a plurality of reflecting structures 70 before reaching the transponder 20.

The wireless sensor 40 is operable to produce the reference signal and the measurement signal, both of which are derived from the RF interrogation signal 50. As will be described in detail below, the reference signal is delayed by a first time delay that is optionally a function of the physical property to be determined, and the measurement signal is delayed by a second time delay that is a function of the physical property to be determined. Since the system uses intrinsic time delay, the response from the sensor occurs after the multi-path ringdown of the RF interrogation signal is finished. The use of two delayed reflections from the SAW device permits the induced variations in the propagation environment to be cancelled, and the induced strain or temperature to be derived. The time delays of the two reflected signals are detected by the transponder and measured at the signal processing unit. This measurement may then be used to estimate the value of the physical property.

For the purposes of describing and defining the present invention, it is noted that the term “ringdown” is utilized herein to refer to the process of the energy decay of a radio frequency signal in a multi-path clutter environment. Similarly, “multi-path ringdown time” refers to the time required for the multiple reflections of a radio frequency signal in a multipath environment to decay to a low enough value to be statistically or empirically insignificant.

The signal processing unit 30 is electrically coupled to the transponder 20 and is operable to compare the reference signal and the measurement signal in the time domain and, using this comparison, determine the physical property of the structural member. In one embodiment, the comparison may include measuring the time difference between the reference signal and the measurement signal. In another embodiment, the comparison may involve taking the ratio of the time delay of each signal. Other methods of making the comparison in the time domain may be known to those skilled in the art.

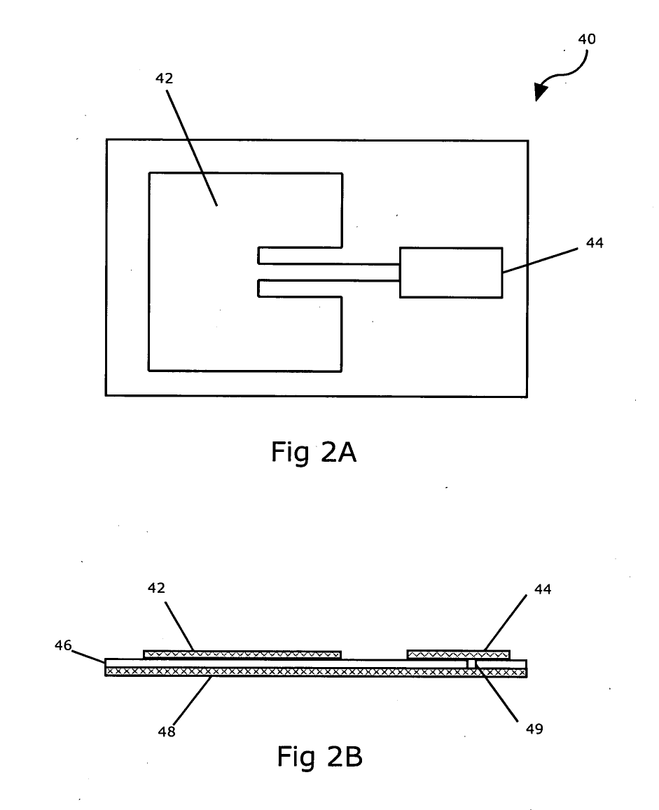

FIGS. 2A and 2B depict an exemplary wireless sensor. In this embodiment, the wireless sensor 40 comprises a patch antenna 42 electrically coupled to a surface acoustic wave (“SAW”) device 44. The patch antenna 42 is operable to receive and send wireless signals, and it is electrically coupled to the SAW device 44. FIG. 2B shows a side view of one embodiment of a wireless sensor 40. The sensor may be of a layered construction, with the patch antenna 42 and the SAW device 44 on the top, a dielectric layer 46 in the middle, and a ground plane 48 on the bottom. The SAW device may be in electrical communication with the patch antenna 42. The SAW device may also be in electrical communication with the ground plane 48 through a via 49, which passes through the dielectric layer 46. The entire sensor package including the SAW device and the antenna may be made with a thickness of less than 1/10 mm. Other types of sensor embodiments are contemplated, including sensors with different geometries, as may be found in the art or yet to be discovered.

The wireless sensor is mechanically coupled to the structural member of which the physical property is being measured. The wireless sensor may be coupled to the structural member in a variety of ways as is known to those skilled in the art. As an illustrative example, the coupling may be through an adhesive. Furthermore, it is contemplated that the physical property being measured may include strain, temperature, and pressure. Other physical properties may be measured as can be gleaned from the technical literature or yet-to-be-discovered technology.

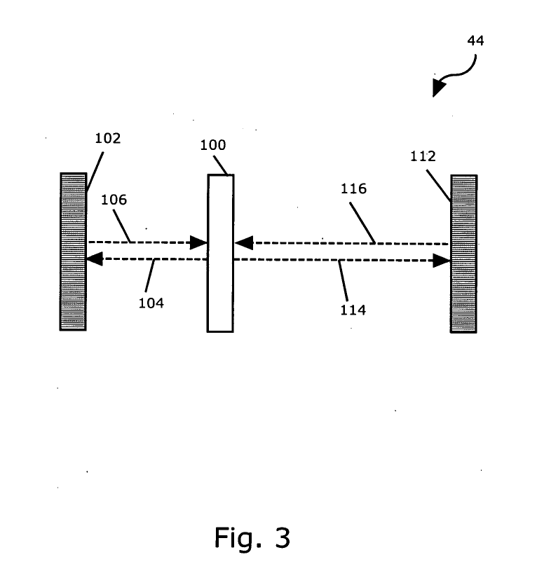

FIG. 3 depicts an exemplary SAW device according to one embodiment. The use of SAW devices as temperature and strain sensors is generally known in the art. A SAW device is a piezoelectric crystal structure that is driven with a transducer, commonly referred to as an interdigital structure 100. The result is that the RF interrogation signal received by the interdigital structure 100 is converted to an acoustic signal where the velocity of propagation is approximately 10,000 times slower (and thus the time delay is 10,000 times longer) than what would happen in free space. The acoustic waves travels in at least two directions away from the interdigital structure 100. One acoustic wave, the incipient reference wave 104, travels from the interdigital structure 100 toward the reference reflector 102. The incipient reference wave 104 reflects off the reference reflector 102 and becomes the reflected reference wave 106. The reflected reference wave 106 travels back to the interdigital structure 100 and is converted back to an electromagnetic signal which is transmitted by the patch antenna. In a like fashion, a second acoustic wave, called the incipient measurement wave 114, travels from the interdigital structure 100 toward the measurement reflector 112. The incipient measurement wave 114 reflects off the measurement reflector 112 and becomes the reflected measurement wave 116. The reflected measurement wave 116 travels back to the interdigital structure 100 and is converted back to an electromagnetic signal which is transmitted by the patch antenna.

As discussed above, because the acoustic wave is much slower than an electromagnetic wave in space, both reference waves 104, 106 and both measurement waves 114, 116 are delayed by an amount of time equal to the travel time of the waves through the piezoelectric crystal structure. Furthermore, since the reference reflector 102 and the measurement reflector 112 are located at different distances from the interdigital structure 100, the amount of time required for the reference wave to travel is different than the amount of time required for the measurement wave to travel. As a result, when the waves are converted back to electromagnetic signals by the interdigital structure and transmitted by the patch antenna, the transmitted reference signal and the transmitted measurement are separated in the time domain.

The physical property (strain variation or temperature variation) of the structure to be sensed may induce strain or temperature variations in the SAW device that cause small changes in the time delay of the waves reflected back from the SAW device. As an illustrative example, an increase in the temperature of the SAW device (corresponding to an increase in temperature of the structural member being measured) may cause the propagation time of the reference waves and/or measurement waves in the SAW device to either increase or decrease. As a result, the reference signal and the measurement signal transmitted by the patch antenna of the wireless sensor will also change a corresponding amount in the time domain. This change can be captured by the transponder and measured by the signal processing unit, thus determining the temperature of the structural member.

Because the RF interrogation signal is transmitted in a dynamic multi-path clutter environment, the RF interrogation signal reflects off the reflecting structures. Many of these reflected signals are returned to the transponder without having reached the wireless sensor. These reflected signals eventually decay since some energy of the signal is lost at each reflection. This process is called multi-path ringdown. As an illustrative example, a 2.5 GHz interrogation wave may require approximately 15 nanoseconds to decay when the measuring system is disposed in a commercial jet aircraft engine.

During the multi-path ringdown, many of these reflected RF interrogation signals may be received by the transponder. As a result, during this time, it may be more difficult for the transponder to distinguish between the decaying RF interrogation signals and the reference and measurement signals. Consequently, the wireless sensor may be designed such that the time delay introduced into the reference signal and the measurement signal may be longer than the amount of time required for the multi-path ringdown. In such a case, the multi-path ringdown will not interfere with the reception of the reference signal or the measurement signal.

As previously indicated, the use of two different time delays on the same SAW device permits a reference signal and a measurement signal to be transmitted to the transponder. The differential delay is a measure of the change in wave velocity on the sensor. Since the differential time may be very short (100 nanoseconds or less), the geometry of the propagation environment does not change significantly during that time, even in the case of the compressor or turbine stage of a jet engine. Thus the differential time delay is not modified by the propagation environment. The basic time delay overcomes the multi-path ringdown problems of spurious reflection signals overlapping the desired data terms, and the use of differential delays overcomes the problem of induced modulation of the propagating signals by the changing propagation environment (As an example, it may be an operational jet engine)

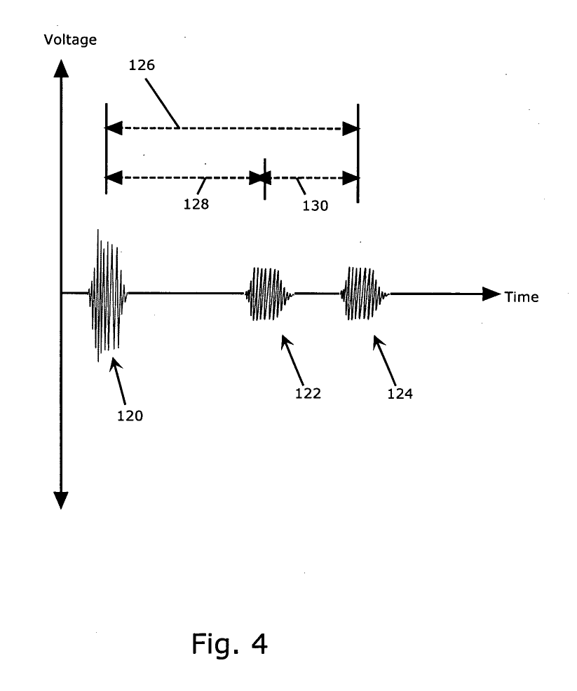

Referring now to FIG. 4, the temporal relationship between the RF interrogation signal, the reference signal, and the measurement signal will now be discussed. To begin a measurement, an RF interrogation signal 120 is sent by the transponder to the wireless sensor. As discussed above, the wireless sensor responds with a reference signal 122 and a measurement signal 124, both of which are delayed in time. The reference signal 122 is delayed from the RF interrogation signal 120 by an amount of time referred to as a reference delay 128. The measurement signal 124 is likewise delayed from the RF interrogation signal 120 by an amount of time referred to as a measurement delay 126. As previously discussed, the reference delay 128 and the measurement delay 126 may be longer than the multi-path ringdown caused by the RF interrogation signal 120. The transponder may receive the reference signal 122 and the measurement signal 124 and communicate them to the signal processing unit. The signal processing unit may compare the reference signal 122 and the measurement signal 124 in the time domain. This time-domain measurement may determine the sensor delay 130 between the reference signal 122 and the measurement signal 124. This sensor delay 130 may be received by the transponder and determined by the signal processing unit.

Referring back to FIG. 1, the signal processing unit 30 may be operable to receive the reference and measurement signals from the transponder 20. In one embodiment, the signal processing unit 30 may split reference signal from the measurement signal so as to delay one or both of the signal and correlated with each other by use of a microwave mixer and low pass filter. The resulting filtered signals may be sampled by an analog-to-digital converter and processed in the system computer (not shown). The mixer may have both in-phase and quadrature phase outputs so that the differential phase can be extracted using a mathematical arctangent in the post processing.

In another embodiment, the signal processing unit 30 receives and amplifies the reference and measurement signals. The amplified signals are input to a microwave quadrature mixer. High speed switches may be used to create the RF interrogation signal and prevent it from interfering with the received signals. A microwave splitter is used to provide a reference (or local oscillator) signal to the quadrature mixer. The outputs of the quadrature mixer can be filtered, for example, with a low pass filter with a cutoff frequency of 20 MHz or less. The in-phase and the quadrature phase signals are fed to the analog-to-digital converter, which converts these signals into a digital format capable of being further processed by a computer (not shown).

These are only two exemplary embodiments of the signal processing unit. Many other variations of the signal processing unit are contemplated, as may be known to those skilled in the art.

For the purposes of describing and defining the present invention, it is noted that the term “wireless” as utilized herein refers generally to the wireless transmission of signals, as opposed to the absence of wires in a particular device. It is also noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present invention or to emphasize alternative or additional features that may or may not be utilized in a particular embodiment of the present invention.

For the purposes of describing and defining the present invention it is noted that the term “approximately” is utilized herein to represent the inherent degree of uncertainty that may be attributed to any quantitative comparison, value, measurement, or other representation. For example, it is stated that the multi-path ringdown may take approximately 15 nanoseconds for a 2.5 GHz interrogation pulse. Because the ringdown may be exponential, the point in time at which the ringdown is considered complete could be the point at which the ringdown signals have decayed to 90% of the initial value.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A method for determining a physical property of a structural member in a dynamic multi-path clutter environment, the method comprising:
transmitting an RF interrogation signal to a wireless sensor physically coupled to the structural member in the dynamic multi-path environment, wherein the wireless sensor is operable to receive the RF interrogation signal, produce a reference signal and a measurement signal, and transmit the reference signal and the measurement signal in the dynamic multi-path clutter environment, wherein
the reference signal and the measurement signal are derived from the RF interrogation signal,
the reference signal is delayed by a first time delay,
the measurement signal is delayed by a second time delay that is a function of the physical property to be determined, and
the first and second time delays are associated by a known relationship defined by the wireless sensor;
receiving the transmitted reference signal and the transmitted measurement signal; and
comparing the transmitted reference signal and the transmitted measurement signal in the time domain and, using this comparison, determining the physical property of the structural member.

2. A method according to claim 1 wherein the reference signal is delayed by a first time delay that is a function of the physical property to be determined.

3. A method according to claim 1 wherein the first time delay and the second time delay are greater than a multi-path ringdown time of the RF interrogation signal.

4. A method according to claim 1 wherein the wireless sensor produces the reference signal and the measurement signal without the use of a power source.

5. A method according to claim 1 wherein the structural member is a blade of a compressor or a turbine in a jet engine.

6. A method according to claim 1 wherein the structural member is part of a helicopter blade mechanism.

7. A method according to claim 1 wherein the structural member is a gear, a gear tooth, or a gear carrier in a transmission.

8. A method according to claim 1 wherein the structural member is rotating or translating machinery or a link in a kinematic mechanism.

9. A system for determining a physical property of a structural member in a dynamic multi-path clutter environment, the system comprising a transponder, a wireless sensor, and a signal processing unit, wherein:
the transponder is operable to transmit a wireless RF interrogation signal to the wireless sensor in a dynamic multi-path clutter environment and receive wireless signals transmitted by the wireless sensor in a dynamic multi-path clutter environment;
the wireless sensor is operable to receive the RF interrogation signal transmitted by the transponder, produce a reference signal and a measurement signal, and transmit the reference signal and the measurement signal in the dynamic multi-path clutter environment;
the reference signal and measurement signal are derived from the RF interrogation signal;
the reference signal is delayed by a first time delay;
the measurement signal is delayed by a second time delay that is a function of the physical property to be determined; and
the signal processing unit is electrically coupled to the transponder and is operable to compare the reference signal and the measurement signal in the time domain and, using this comparison, determine the physical property of the structural member.
